(19) United States
(12) Patent Application Publication
(10) Pub. No.: US 2013/0241701 A1
(43) Pub. Date: Sep. 19, 2013

(54) SYSTEM AND METHOD FOR UPDATING PARAMETERS AND FIRMWARE ON RFID READERS

(71) Applicants: Philip John Almond, Redcliffe (AU); Hendrik Lodewyk Van Eeden, Moreletapark (ZA); Roger Wilton Dunn, Kippa Ring (AU)

(72) Inventors: Philip John Almond, Redcliffe (AU); Hendrik Lodewyk Van Eeden, Moreletapark (ZA); Roger Wilton Dunn, Kippa Ring (AU)

(73) Assignee: TRIDENT RFID PTY LTD, Brisbane, Queensland (AU)

(21) Appl. No.: 13/823,106

(22) PCT Filed: Sep. 13, 2011
(86) PCT No.: PCT/NZ2011/000188

§ 371 Date: May 31, 2013

(30) Foreign Application Priority Data
Sep. 13, 2010 (NZ) 587938

(51) Int. Cl. G06K 7/10

(52) U.S. Cl. CPC G06K 7/10198
USPC 340/10.1

(57) ABSTRACT

A method for wirelessly transferring operational information to an RFID reader using a tag-reader air interface.

An RFID tag emulator capable of formatting operational information for an RFID reader into a standard RFID tag transmission signal format and transmitting it as a standard RFID tag transmission signal that may be read by a standard RFID reader.

An RFID reader that can read information formatted in a standard RFID tag transmission signal format and extract operational information and storing it for use in the operation of the RFID reader.

### BACKGROUND

This invention relates to wireless radio frequency identification (RFID) systems and more particularly to a system and method for wirelessly updating configuration parameters and firmware on readers (also called interrogators) forming part of such a system, by means of the reader-tag air interface.

RFID systems are known in which a plurality of RFID readers are deployed, either at a single read point or at various read points throughout a system, some of which may be remote. Examples of such systems include, but are not limited to:
Sport time keeping systems that use RFID tags attached in some way to competitors to identify such competitors when they cross a starting line, finish line or at intermediate points along a race course. Simultaneously with identifying the competitors, the time at which they were identified is also logged in order to generate event results or other timing information of interest, such as split times.
Vehicle tolling systems in which vehicles are identified and time-stamped at points along a motorway in order to levy tolls or gather other ITS (Intelligent Transport Systems) related information such speed of travel and traffic density.
Supply chain management systems in which readers are deployed e.g. at manufacturers or producers, shipping ports, distribution centers and retailers in order to identify and time-stamp goods, containers or returnable transport items along the supply chain for the purpose of tracking such goods and for gathering information relating to arrival and departure times along such a supply chain.

The RFID tags (also known as transponders) and readers used in such systems are typically ISO/IEC 18000 compliant readers and passive or active tags, but could also be other non-standard tags such as IP-X DF tags and readers. Readers and tags communicate wirelessly with each other using the so-called “air interface”, a radio frequency communication protocol between reader and tags. In the case of passive tags, the reader transmits RF energy to the tags, which is rectified by the tag and used to power the tag. Communication from reader to tag (the “forward link”) is typically done by modulating the

RF energy, while communication from tag to reader (the “return link”) is done by backscatter modulation, i.e. the tag modifies its own reflection coefficient by modulating the load on its antenna. Semi-active or battery assisted tags are powered by a battery, but communicate in the same manner as passive tags using backscatter modulation. Active tags are battery powered and contain active RF transmitters for communicating with readers. Tags typically return an identification code (ID) or Unique Item Identifier (UII, also sometimes called an EPC code) to the reader. The reader may also make use of read commands to obtain additional information from the tags.

In any such distributed deployment of RFID readers, a number of problems arise:
1. It is difficult to time synchronize all the readers in the system. This is especially true of sport time keeping systems, where timing accuracy to 10 ms or better is required across all readers in the system, whether these are multiple readers at a single read point such as the finish line or readers distributed along the race course. A known solution is to connect all the readers to an NTP server, however, this requires a network to be set up, and might require wireless communications to the central NTP server, especially if the timing points are widely distributed, e.g. along the route of a marathon race. This solution might be impractical for smaller amateur races, where setup time and available funds may be limited. This solution also requires powerful and expensive controller processors in each of the RFID readers, typically capable of running a form of UNIX, Linux or Windows. This method also introduces a source of timing inaccuracy, since the received IDs or EPC codes are not time-stamped at the point of reception, but rather in the controller, at which point delays could have been incurred through buffering and transmission of the received IDs or EPC codes. An alternative solution would be to install GPS receivers in all RFID readers. However, this could add greatly to the cost of the reader, and might not be feasible for readers installed indoors or at points where there is no GPS reception.
2. It is difficult to determine and log the actual geographical point of installation, e.g. at which point along a race route, at which tolling point along a highway or at which facility or read point in a supply chain application the readers are installed.
3. It is difficult to set up and update various operating parameters, such as frequency of operation, tag and communication baud rates, regulatory jurisdiction, modulation techniques, etc. This is especially true of a new installation or of a replacement of an existing (possibly faulty) reader with a new one. In both cases it may be required to configure the reader after installation to match the requirements of the system at that read point. While such configuration could be and is often done over a network, some configuration may be installation dependant and might be easier and more effectively accomplished on site at installation.

It would be desirable to provide an effective and cost efficient solution to the above mentioned problems of time synchronization, geographical positioning or other parameter updates including possibly firmware and software updates of multiple RFID readers deployed in a system, by using the system's wireless tag-reader air interface protocol. The patent proposes a tag emulator that may contain a GPS receiver, and which may be able to emulate an IP-X DF tag or any ISO/IEC 18000 tag, but with the emulated tag response (ID or UII code) specially formatted to contain time and/or geographical position information (possibly obtained from an on-board GPS unit), or other setup parameters or firmware. When a reader detects this specially formatted tag message, it is able to update its own Real Time Clock (RTC), log its own geographical position or update its setup parameters or firmware from the information contained in the tag message. Multiple readers in a system can be updated by merely manually bringing the tag emulator into each of the readers' reading fields. This can be done in any manner, i.e. no specific sequence or temporal requirements need to be met.

### SUMMARY OF THE INVENTION

According to the invention there is provided a tag emulator for a radio frequency identification system, the emulator comprising a suitable antenna (LF, HF, UHF or microwave) and an electronic circuit comprising:
a. a controller for emulating the relevant tag-reader air interface
b. a transmitter or antenna modulator for generating a tag response.
c. a power source (typically a battery);
d. possibly a GPS receiver;
e. possibly a Real Time Clock (RTC);
f. storage means for storing parameters or firmware updates;

The tag emulator is capable of executing the required air interface, whether it be one of the air interfaces specified in ISO/IEC 18000, the IP-X DF or UHF air interface, or any other proprietary air interface as might be required. However, instead of responding with an ID, UII code or other tag data, the emulator responds with parameter information, formatted like tag data, but with distinguishing features such as a special header to distinguish it from a normal tag response. The transmitter or antenna modulator is able to generate a tag response either actively or by means of modulated backscatter.

There is also provided an RFID reader, capable of executing the required air interface (ISO/IEC 18000, IP-X or any proprietary protocol), but capable of recognizing the specially formatted tag response as described above, and able to update its configuration parameters from the information embedded in the emulated tag response.

There is further provided an RFID reader including:
a. a receiver capable of receiving signals formatted in a standard RFID tag transmission signal format;
b. a processor capable of extracting operational information contained in received signals in standard RFID tag transmission signal format; and
c. memory for storing extracted operational information for use in the operation of the RFID reader.

There is further provided a method for wirelessly transferring operational information to an RFID reader using a tag-reader air interface; the method comprising:
a. transmitting operational information in a format emulating a response from an RFID tag; and
b. receiving the transmitted operational information at the RFID reader and utilizing it by the RFID reader.

There is also provided a system for wirelessly transferring operational information to an RFID reader using the tag-reader air interface; the system comprising:
a. one or more RFID tag emulators as claimed in claims 1 to 17; and
b. one or more RFID readers as claimed in claims 18 to 30.

### BRIEF DESCRIPTION OF THE DRAWINGS

The invention will now further be described, by way of example only, with reference to the accompanying diagrams wherein:

FIG. 1 is a basic block diagram of the layout a typical race course showing multiple deployed RFID readers;

FIG. 2 is a basic block diagram of a typical IP-X DF tag as used in sports time keeping applications;

FIG. 3 shows the response waveform of an IP-X DF tag;

FIG. 4 shows the ID structure for an IP-X DF tag;

FIG. 5 is a basic block diagram of the tag emulator according to the invention;

FIG. 6 shows the time parameter structure for an IP-X DF tag emulator; and

FIG. 7 shows the coordinate parameter structure for an IP-X DF tag emulator.

### DESCRIPTION OF A PREFERRED EMBODIMENT OF THE INVENTION

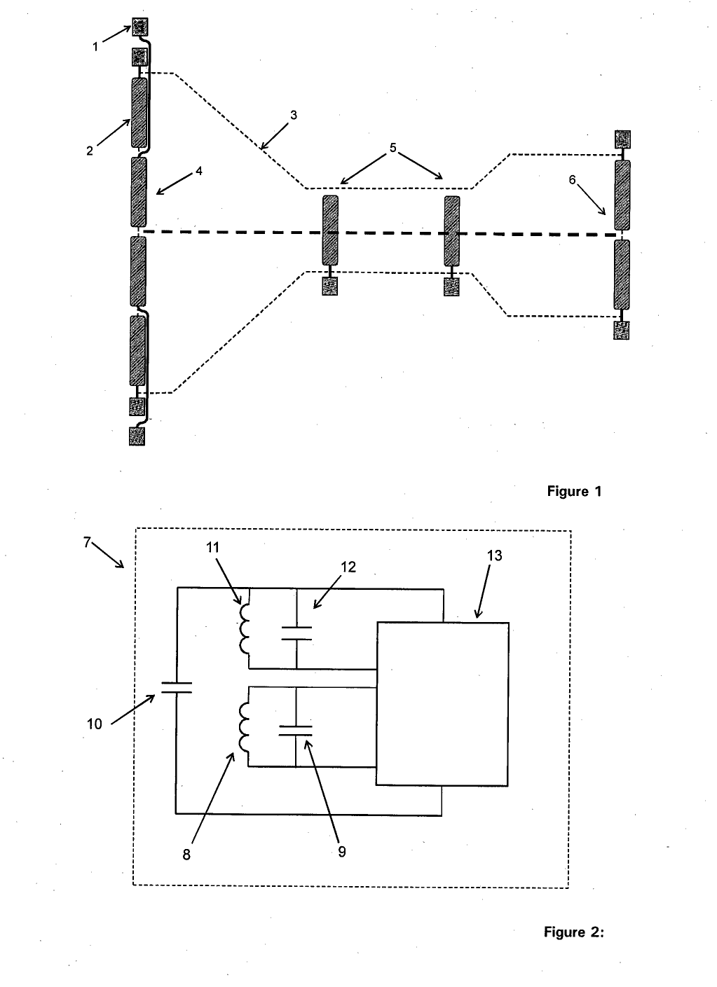

One preferred embodiment of the invention is in the field of sports time keeping, for example, but not limited to, road running or cycling. Multiple IP-X DF readers are deployed at the start line (4), finish line (6) and along the race course (5), for recording the start, split and finish times of competitors. FIG. 1 shows a diagrammatic representation of such a system. As can be seen from the diagram, multiple readers (1) may be deployed at a single read point, in order to cover a wide race course (3). The reader antennas are in the form of mats (2) laid out across the track. Tags are attached to competitors (around their ankles or embedded in their race numbers) or their bicycles. As these tags pass over the mats, a 64 bit ID number is transmitted to the reader, using the IP-X anti-collision air protocol. The 64 bit ID number is associated with the race number of the competitor. As each competitor is identified by the reader, a time-stamped record is created in a data base, from which race results can be generated. The time stamp is obtained from an accurate Real Time Clock (RTC) inside the reader. Using an RTC with a specification of 4 ppm, an error of about 15 ms can accumulate in one hour, and about 0.1 s in seven hours. This might be good enough for a mass participation marathon road race, where an accuracy of 0.1 s for the slower competitors is sufficient. However, between races, errors in the RTC can accumulate to about 2.5 s per week, which is no longer acceptable. It thus becomes necessary to update the RTCs of all the readers after deployment and close before the start of the race. This is especially true when multiple readers are deployed at one read point. In such a case it is possible that a competitor will be detected by more than one reader and it is possible that, unless properly synchronized, the readers can generate conflicting time records for the same competitor.

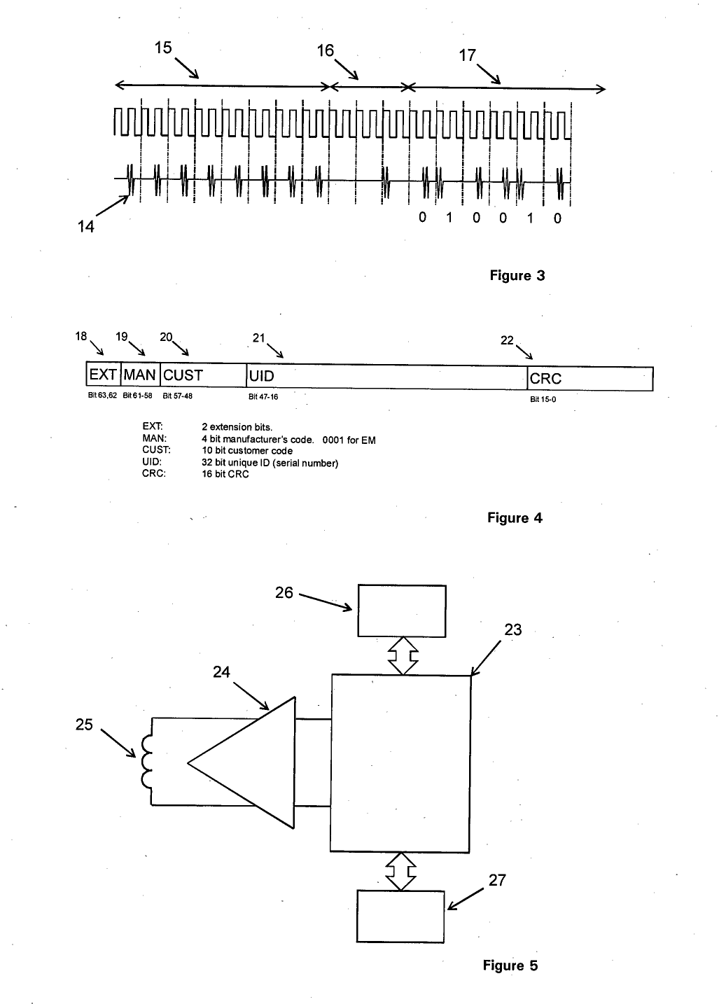

A block diagram of an IP-X DF tag (7) is shown in FIG. 2. The tag receives energy through an antenna (8), tuned to resonate at 125 kHz by means of a capacitor (9). The rectified energy is stored in a capacitor (10) to be used to power an integrated circuit (13) and to supply energy for a response. The integrated circuit rectifies the received energy, executes the IP-X air protocol and responds via an antenna (11), tuned by means of a capacitor (12) to ring at 6.78 MHz. The IP-X DF tag response waveform is shown in FIG. 3. The response uses Pulse Position Encoding (PPE), with a ‘1’ represented by a 6.78 MHz pulse stream (14) during the first quarter of a bit period, and a ‘0’ represented by a 6.78 MHz pulse stream during the third quarter of a bit period. The response starts with eight ‘0’ start bits (15), followed by a sync (16) consisting of two blank bit periods followed by a ‘1’. After the sync the 64 bits of the ID (17) is transmitted. The bit rate is nominally 128 kbit/s, so a complete transmission takes nominally 586 μs.

FIG. 4 shows the ID structure for the. IP-X DF air protocol. It consists of two extension bits (18), 4 bit manufacturer code (19), 10 bit customer code (20), 32 bit unique ID (21) and finally a 16 bit CRC (22). The extension bits have following meanings:
“00”—read-only IP-X ID
“01”—read/write IP-X ID
“11”—ISO structured data
“10”—future extensions

It is thus possible to distinguish parameter data intended for the reader from normal IDs, by using the value “10” for the extension bits.

In this first preferred embodiment a battery driven hand-held IP-X DF tag emulator is used to time synchronize and geographically position all the deployed readers before the start of the race. FIG. 5 shows a block diagram of such a tag emulator. The emulator contains a controller (23), a transmitter (24), a 6.8 MHz antenna (25), a GPS receiver (26) and a 4 ppm or better RTC (27). The controller executes the IP-X DF air protocol as explained above, but instead of sending an ID, it sends either a time value or coordinate values formatted as explained below. The emulator's RTC is maintained from the GPS receiver time when a GPS signal is present. When the GPS signal is not present, the RTC is accurate enough to be used as backup source of time for some period depending on the required accuracy, e.g. if better than 10 ms accuracy is required, the RTC time would be within requirement for about 20 s after the last GPS fix. The controller also has storage means to keep the last known GPS coordinates. The emulator can be configured by mean of bit switches or a stored configuration value (not shown) to transmit either time, geographical coordinates or both.

The GPS receiver provides a so-called “1 PPS” signal, a pulse on the second at each second. The time value is to the nearest second and is valid on the next 1 PPS pulse. The emulator starts a time message transmission nominally 586 μs before the next 1 PPS pulse (or 999.414 ms after the previous 1 PPS pulse). The message would thus terminate on the second, allowing the reader to update its own RTC correct to the second. The reader then uses an internal counter or software timing loop (also called a “millisecond counter”) to generate interpolated time stamps to the accuracy needed, typically to the nearest 1 ms or 10 ms.

The emulator transmits time messages and/or coordinate messages every second when it is turned on. The tag emulator can be brought manually into each reader's beam, e.g. just by walking with the emulator across all the deployed timing mats in the system. Additional tag emulators can be used at reading points that are geographically distant, i.e. where it might be problematic to reach all the readers in a reasonable time before the start of the race. This results in all the readers at a single read point being time synchronised to the same emulator time (GPS or estimated GPS) and all readers along the race route also being time synchronised to GPS time.

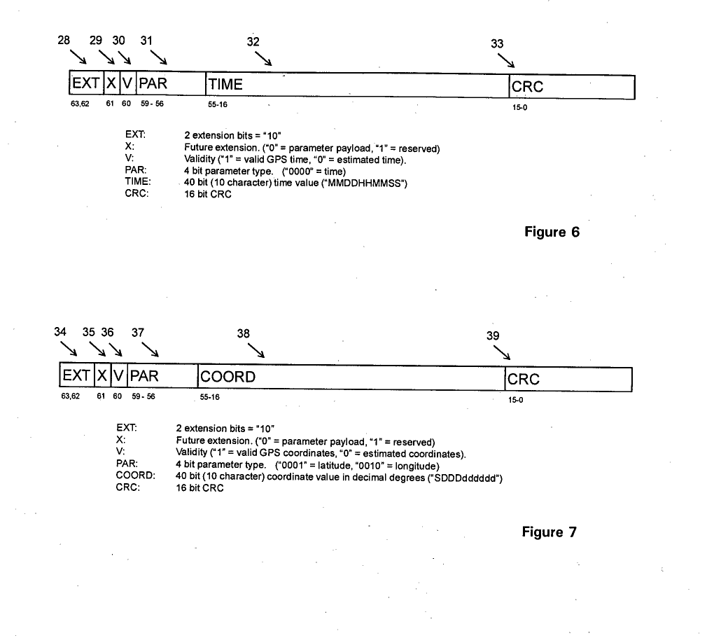

FIG. 6 shows the transmitted format to be used for a time value. As for a normal ID, the transmission is 64 bits in length and starts with two extension bits (28), but with the value “10” to indicate that the transmission is not a normal ID. The extension bits are followed by a bit (29) indicating a parameter payload (“0” for parameter payload, “1” reserved for future extensions) and a bit (30) indicating whether the time is GPS time or estimated time (from the RTC). The next four bits (31) indicate the type of parameter (“0000” for time“). The next forty bits (32) allow for a ten character time value of the format “MMDDHHMMSS”. The last 16 bits (33) is a CRC-16 just as for a normal ID. A GPS time message would therefore start with 0×90 and an RC time message with 0×80.

FIG. 7 shows the transmitted format to be used for a coordinate value. As for a normal ID, the transmission is 64 bits in length and starts with two extension bits (34), but with the value “10” to indicate that the transmission is not a normal ID. The extension bits are followed by a bit (35) indicating a parameter payload (“0” for parameter payload, “1” reserved for future extensions) and a bit (36) indicating whether the coordinate is a valid GPS coordinate or estimated coordinate, i.e. no GPS signal available. The next four bits (37) indicate the type of parameter (“0001” for latitude and “0010” for longitude”). The next forty bits (38) allow for a ten character coordinate value in decimal degrees of the format “SDDDdddddd”. The “S” is the sign bit (“0”=“+” and “1”=“−”). The last 16 bits (39) is a CRC-16 just as for a normal ID. A GPS latitude message would therefore start with 0×91 and a GPS longitude message would start with 0×92. An estimated latitude message would therefore start with 0×81 and an estimated longitude message would start with 0×82.

The various parameter message starts are summarized in Table 1 below.

TABLE 1
Emulator message starts

| Message start | Meaning |
|---|---|
| 0x80 | Estimated time |
| 0x81 | Estimated latitude |
| 0x82 | Estimated longitude |
| 0x90 | GPS time |
| 0x91 | GPS latitude |
| 0x92 | GPS longitude |

It is to be noted that IP-X and ISO/IEC 18000-6D are “Tag Talks First” (TTF) protocols, as opposed to e.g. ISO/IEC 18000-6C, which is a Reader Talks First” (RTF) protocol. In practice this means that an IP-X tag emulator could transmit a time parameter message at any time, e.g. on the second as described in the preferred embodiment. The time parameter message thus only has to be specific to the nearest second. In an RTF protocol, however, the tag response is in reply to a reader command. The timing of the response is thus determined by the reader, and a time parameter message would have to include the fraction of the second (to the nearest 10 ms or 1 ms, as might be required) at the time of the response. The reader receiving such a message would have to set its own RTC to the integer second, but would also have to initialize its millisecond counter to the fraction of the second.

In the IP-X and ISO/IEC 18000-6D air protocols, the basic ID response is just 64 bits long, so the message formats proposed in the preferred embodiment are constrained to be 64 bits long. However, both. IP-X and ISO/IEC 18000-6D allow for multiple 64 bit packets to be transmitted. This feature can be used to transmit parameter sets or even firmware updates to the reader. In the ISO/18000-6C and related air protocols, the UII is limited to 496 bits in length (please refer to the ISO/IEC 18000-6 standard for details of the air protocol). This would allow for multiple parameters to be transmitted to a reader in a single response message, e.g. time, latitude and longitude parameters could be included in a single message. However, 496 bits would in general not be enough to transmit a firmware update. In this case the firmware update could be held in USER memory in the tag emulator. The parameter message need only specify a starting address and length in USER memory, and the reader can then use the

READ command as provided in the air protocol to retrieve the firmware update.

It will further be appreciated that there are many variations in detail on the emulator electronic circuit and message formats and method according to the invention, without departing from the scope and spirit of this disclosure.

1. A system for reconfiguring an RFID reader by means of a tag-reader RF interface, including:
a. a processor capable of emulating an RFID tag air interface and capable of formatting operational information for said RFID reader into a standard RFID tag transmission signal format that may be read by a standard RFID reader; and
b. a transmitter capable of emulating an RFID tag response signal and transmitting the said formatted reader operational information as a standard RFID tag transmission signal that may be read by a standard RFID reader.

2. A system as claimed in claim 1 wherein the tag emulator is capable of emulating an IP-X DF tag or an ISO/IEC 18000 tag.

3. A system as claimed in claim 1 wherein the transmitter is an active transmitter.

4. A system as claimed in claim 1 wherein the transmitter is an antenna modulator capable of generating passive backscatter.

5. A system as claimed in claim 1 wherein the operational information includes time information to be used to set or update a Real Time Clock (RTC) in the reader.

6. A system as claimed in claim 1 wherein the operational information includes geographical position information in order to provide a reader with its own geographical position.

7. A system as claimed in claim 1 wherein the operational information includes one or more reader set-up parameter possibly selected from, but not limited to, air interface, communication baud rate, IP address, frequency of operation, mode of operation, regulatory jurisdiction and modulation techniques.

8. A system as claimed in claim 1 wherein the operational information includes firmware updates or parameters as to how the firmware updates can be retrieved from the tag emulator.

9. A system as claimed in claim 1 wherein the tag emulator contains an RTC for providing time information to be transmitted to the readers.

10. A system as claimed in claim 1 wherein the tag emulator time contains a GPS receiver.

11. A system as claimed in claim 10 wherein the tag emulator contains a backup RTC which is maintained from the GPS time when a GPS signal is available, and which can provide time information to be transmitted when a GPS signal is not available.

12. A system as claimed in claim 9, or wherein the time message transmitted by the tag emulator is offset to compensate for any time delays that might occur between the time the message is sent and the time the RTC is updated.

13. A system as claimed in claim 10 in which the tag emulator contains storage means for storing the last known geographical position supplied by the GPS, for transmission to a reader when a GPS signal is not present.

14. A system as claimed in claim 10 in which an indication is transmitted to the reader whether a GPS signal is present or not.

15. A system as claimed in claim 1 in which the emulated tag message is cover-coded or encrypted to prevent unauthorized operational information transfer to a reader.

16. A system as claimed in claim 1 in which multiple tag messages are used to transmit more operational information than would fit into a single tag message.

17. A system as claimed in claim 1 wherein for the transfer of a large amount of operational information to a reader a memory address and length or a range of memory addresses is specified in the initial message to the reader, whereafter the reader can access the information from the tag emulator using air interface commands.

18-32. (canceled)

33. A system as claimed in claim 1 wherein the reader operational information is specially formatted to distinguish such reader operational information from other tag transmissions and data, so that the reader may be able to recognize such reader operational information in order to utilize it for reconfiguring itself.

34. A system as claimed in claim 10 wherein the time message transmitted by the tag emulator is offset to compensate for any time delays that might occur between the time the message is sent and the time the RTC is updated.

35. A system as claimed in claim 11 wherein the time message transmitted by the tag emulator is offset to compensate for any time delays that might occur between the time the message is sent and the time the RTC is updated.
